(19) United States
(12) Patent Application Publication
(10) Pub. No.: US 2025/0284851 A1
(43) Pub. Date: Sep. 11, 2025

(54) BROWSER EXTENSION RECOGNITION SYSTEM

(71) Applicant: Joseph Moschella, Los Angeles, CA (US)

(72) Inventor: Joseph Moschella, Los Angeles, CA (US)

(21) Appl. No.: 19/218,122

(22) Filed: May 23, 2025

Related U.S. Application Data
(63) Continuation of application No. 17/680,071, filed on Feb. 24, 2022.
(60) Provisional application No. 63/153,608, filed on Feb. 25, 2021.

(51) Int. Cl. G06F 21/62; G06F 3/04817; G06F 40/166; G06F 40/289

(52) U.S. Cl. CPC G06F 21/629; G06F 3/04817; G06F 40/166; G06F 40/289

(57) ABSTRACT

A browser extension recognition system and methods are provided for flagging specified words when they are typed into a web-browser application. A warning dialog box is displayed when a typed word or phrase is determined to match a word or phrase in a saved list of the words to be blocked. The warning dialog box indicates that the word or phrase matches a blocked word or phrase and prompts an end-user to continue or stop typing the block word or phrase. Settings are configured to enable the end-user to add new words and phrases to the list of words and remove existing words and phrases from the list of words. A desired group of words and/or phrases to be blocked can be imported from an external file, and an external file containing a listing of all the words and phrases comprising the list of words can be exported.

### PRIORITY

This application claims the benefit of and priority to U.S. patent application Ser. No. 17/680,071 filed Feb. 24, 2022 and U.S. Provisional Application, entitled “Browser Extension Recognition System,” filed on Feb. 25, 2021 and having application Ser. No. 63/153,608, the entirety of said application being incorporated herein by reference.

### FIELD

Embodiments of the present disclosure generally relate to the field of web browser programming. More specifically, embodiments of the disclosure relate to a browser extension recognition system and methods for flagging specified words when they are typed into the browser.

### BACKGROUND

Browser extensions generally are packages of software code that can be installed into a web browser to add new features to the browser. For example, a browser extension can extend existing functionality, modify a visual theme, and the like. A browser extension may be a zipped bundle of files that includes webpages and may use all the application programming interfaces (APIs) that the browser provides to webpages. Browser extensions may include hypertext mark-up language (HTML), cascading style sheets (CSS), JavaScript, images, and other types of files and web-related computer languages and code that facilitates creating new and unique browser configurations.

Embodiments disclosed in the disclosure provide a browser extension recognition system for flagging specified words when they are typed into a browser application.

### SUMMARY

A browser extension recognition system and methods are provided for flagging specified words when they are typed into a web-browser application. A warning dialog box is displayed when a typed word or phrase is determined to match a word or phrase in a saved list of the words to be blocked. The warning dialog box indicates that the word or phrase matches a blocked word or phrase and prompts an end-user to continue or stop typing the block word or phrase. The browser extension recognition system includes settings configured to enable the end-user to add new words and phrases to the list of words and remove existing words and phrases from the list of words. A desired group of words and/or phrases to be blocked can be imported from an external file, and an external file containing a listing of all the words and phrases comprising the list of words can be exported.

In an exemplary embodiment, a browser extension recognition system for enabling end-users to manage a list of words to be blocked from being typed in the browser application comprising: a browser action for installation as a part of the browser application; and a list of words for being blocked in the browser application.

In another exemplary embodiment, a browser action icon is associated with the browser action and displayed in the browser application. In another exemplary embodiment, a recognition system dialog box is configured to be displayed when the browser action icon is selected. In another exemplary embodiment, the recognition system dialog box includes content specified by the browser extension recognition system and instructions contained in one or more background elements that provide functionality for operation of the browser extension recognition system.

In another exemplary embodiment, the recognition system dialog box includes controls configured to enable the end-users to manage the list of words. In another exemplary embodiment, the controls facilitate adding new words and phrases to the list of words and removing existing words and phrases from the list of words. In another exemplary embodiment, the controls include a protection switch configured to switch the browser extension recognition system between an Off state and an On state. In another exemplary embodiment, the controls include a Settings button that is configured to be selected so as to display a settings dialog box.

In another exemplary embodiment, the settings dialog box includes controls configured to enable the end-users to control the operation of the browser extension recognition system. In another exemplary embodiment, the settings dialog box includes a list of all words and phrases to be blocked in the browser application. In another exemplary embodiment, the settings dialog box facilitates adding new words and phrases to the list of words and removing existing words and phrases from the list of words. In another exemplary embodiment, the settings dialog box is configured to enable the end-user to import an external file that contains a desired group of words and/or phrases to be blocked in the browser application. In another exemplary embodiment, the settings dialog box is configured to enable the end-user to create an external file that contains a listing of all the words and phrases comprising the list of words.

In another exemplary embodiment, a warning dialog box is displayed when a word or phrase being typed is determined to match a word or phrase in the list of words. In another exemplary embodiment, the display of the warning dialog box prevents the word or phrase from being completely typed into the browser application. In another exemplary embodiment, the warning dialog box includes a warning indicating that the typed word or phrase matches a blocked word or phrase and prompts the end-user to either continue or stop typing the block word or phrase.

In an exemplary embodiment, a method for blocking words from being typed in a browser application comprises: installing a browser action as a part of the browser application; selecting a browser action icon to display a recognition system dialog box; managing a list of blocked words and phrases; and responding to a warning dialog box when the blocked words and phrases are detected.

In another exemplary embodiment, managing includes adding new words and phrases to the list of blocked words and phrases and removing existing words and phrases from the list of blocked words and phrases. In another exemplary embodiment, managing includes importing an external file that contains the list of blocked words and phrases to be blocked in the browser application. In another exemplary embodiment, managing includes creating an external file that contains a listing of all the words and phrases comprising the list of blocked words and phrases.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 illustrates a screenshot of an exemplary embodiment of a Recognition System dialog box displayed in a browser application;

FIG. 2 illustrates a screenshot of an exemplary embodiment of a Settings dialog box displayed in a browser application;

FIG. 3 illustrates a screenshot of an exemplary embodiment of a Warning dialog box displayed in a browser application;

FIG. 4 illustrates a screenshot of an exemplary embodiment of a Warning dialog box displayed in a web-based mail application;

FIG. 5 illustrates a screenshot of an exemplary embodiment of a Warning dialog box displayed in a web-based mail application; and

FIG. 6 is a block diagram illustrating an exemplary data processing system that may be used with embodiments of a browser extension recognition system according to the present disclosure.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the browser extension recognition system and methods disclosed herein may be practiced without these specific details. In other instances, specific numeric references such as “first window,” may be made. However, the specific numeric reference should not be interpreted as a literal sequential order but rather interpreted that the “first window” is different than a “second window.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

Browser extensions can be installed into a web browser to add new features to the browser, such as extending existing functionality, modifying a visual theme, and the like. Browser extensions may include hypertext mark-up language (HTML), cascading style sheets (CSS), JavaScript, images, and other types of files and web-related computer languages and code that facilitates creating new and unique browser configurations. Embodiments presented herein provide a browser extension recognition system for flagging specified words when they are typed into a browser application.

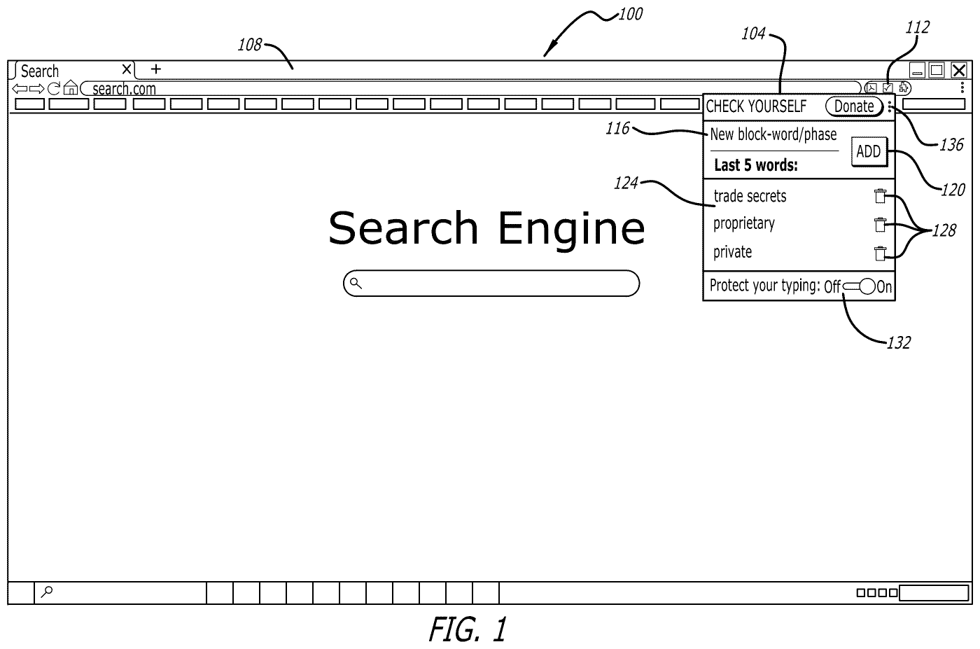

FIG. 1 illustrates a screenshot 100 of an exemplary embodiment of a Recognition System dialog box 104 that may be displayed in a browser application 108. In the illustrated embodiment, the browser application 108 may be a Google Chrome browser application. In some embodiments, the browser extension recognition system disclosed herein may be implemented as a browser action that may be installed as a part of the browser application 108. As such, a browser action icon 112 may be displayed in the main toolbar, to the right of the address bar, as shown in FIG. 1. In some embodiments, the browser action icon 112 may be displayed in any of various other suitable locations of the browser application 108. Further, the browser action may be associated with a tooltip and a badge, as desired. Further, the browser extension recognition system may be associated with one or more background elements that are configured to provide functionality for the operation of the recognition system.

In the embodiment illustrated in FIG. 1, when an end-user selects the browser action icon 112, such as by clicking with a mouse, the Recognition System dialog box 104 is displayed. The Recognition System dialog box 104 may be populated with content as specified by the browser extension recognition system as well as instructions contained in the one or more background elements.

In general, the recognition system dialog box 104 enables end-users to manage a list of words that are to be blocked from being typed in the browser application 108. In the embodiment illustrated in FIG. 1, the Recognition System dialog box 104 includes a New Word text box 116, an Add button 120, a Saved Words list 124, and a Delete button 128 associated with each word in the Saved Words list 124. The New Word text box 116 is configured to allow the end-user to type one or more new words to be blocked from being typed in the browser application 108. The Add button 120 enables the end-user to include the words typed in the New Word text box 116 to the Saved Words list 124. As will be appreciated, the Saved Words list 124 includes a listing of the 5 most recently added words and phrases to be blocked in the browser application 108. A Delete button 128 is associated with each word or phrase in the Saved Words list 124. The end-user may remove any unwanted word or phrase from the Saved Words list 124 by selecting the Delete button 128 associated with the unwanted word or phrase.

With continuing reference to FIG. 1, the Recognition System dialog box 104 further includes a Protection switch 132 and a Settings button 136. The Protection switch 132 is configured to enable the end-user to switch the browser extension recognition system between an Off state and an On state. While in the On state, the browser extension recognition system actively compares any word or phrase being typed into the browser application 108 with the words and phrases included in the Saved Words list 124. If the browser extension recognition system determines that the word or phrase being typed will match a word or phrase in the Saved Words list 124, the browser extension recognition system prevents the word or phrase from being completely typed into the browser application 108. When the end-user uses the Protection switch 132 to put the browser extension recognition system into the Off state, the browser extension recognition system ceases determining whether typed words or phrases match the contents of the Saved Words list 124. Thus, while the browser extension recognition system is in the Off state, the end-user may type words and phrases that are included in the Saved Words list 124 without being blocked.

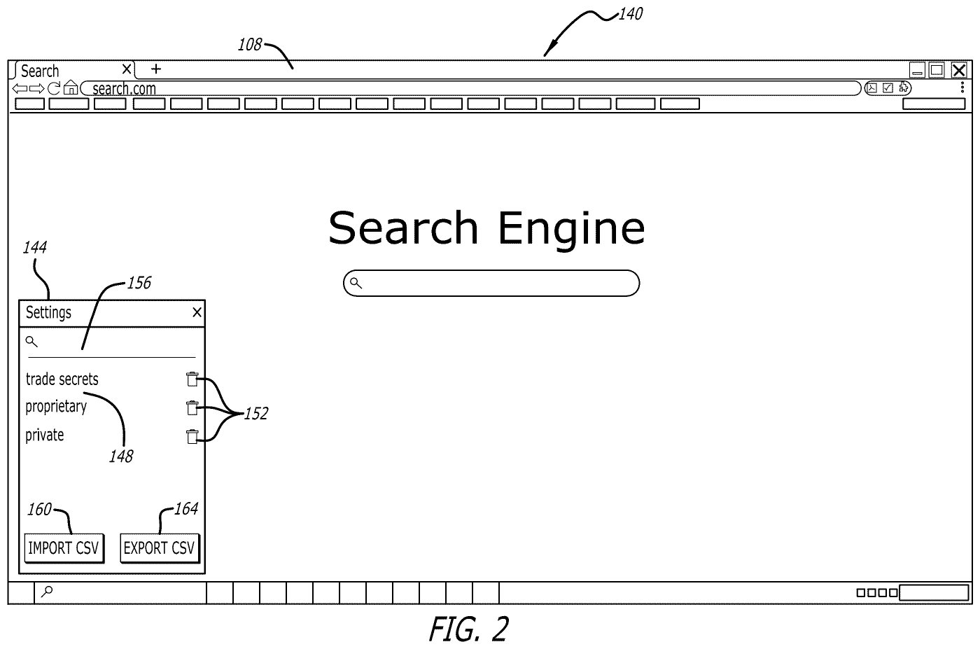

The Settings button 136 is configured to enable the end-user to access various settings that control the operation of the browser extension recognition system. As shown in a screenshot 140, illustrated in FIG. 2, a Settings dialog box 144 may be displayed upon selecting the Settings button 136 of FIG. 1, such as by way of clicking with a mouse. In the embodiment illustrated in FIG. 2, the Settings dialog box 144 includes a Saved Words list 148 and a Delete button 152 associated with each word or phrase included in the Saved Words list 148. The Saved Words list 148 includes all the words and phrases to be blocked in the browser application 108. Further, the Settings dialog box 144 includes a Search box 156 configured to enable the end-user to type a word or phrase to find on the Saved Words list 148. Any unwanted word or phrase may be removed from the Saved Words list 148 by selected the Delete button 152 associated with the unwanted word or phrase in the Saved Words list 148.

As will be appreciated, while the Saved Words list 124 of FIG. 1 includes the 5 words or phrases most recently added to the Saved Words list 124, the Saved Words list 148 of FIG. 2 includes all words and phrases that are to be blocked in the browser application 108. Further, it should be understood that while the Recognition System dialog box 104 facilitates entering individual words and phrases to be blocked, such as by typing in the New Word text box 116, the Settings dialog box 144 includes an Import button 160 that enables entering groups of words and phrases to be blocked. For example, the end-user may select the Import button 160 and then locate an external file that contains a desired group of words and/or phrases to be blocked in the browser application 108. In the illustrated embodiment of FIG. 2, the Settings dialog box 144 is configured to receive a comma-separated values (CSV) file. As such, it is contemplated that any number of words and/or phrases may be grouped into a single CSV file by way of any spreadsheet program, without limitation.

Moreover, the Settings dialog box 144 includes an Export button 164 that enables the end-user to create a CSV file that contains a list of the words and phrases comprising the Saved Words list 148. It is contemplated that during operating the browser extension recognition system, a growing number of words and phrases will be added to the Saved Words list 148 over time. As such, the end-user may periodically use the Export button 164 to create a backup file that includes the current words and phrases included on the Saved Words list 148. Therefore, if a future situation arises wherein the Saved Words list 148 needs to be restored, the end-user may simply select the Import button 160 to load the words and phrased comprising the backup file.

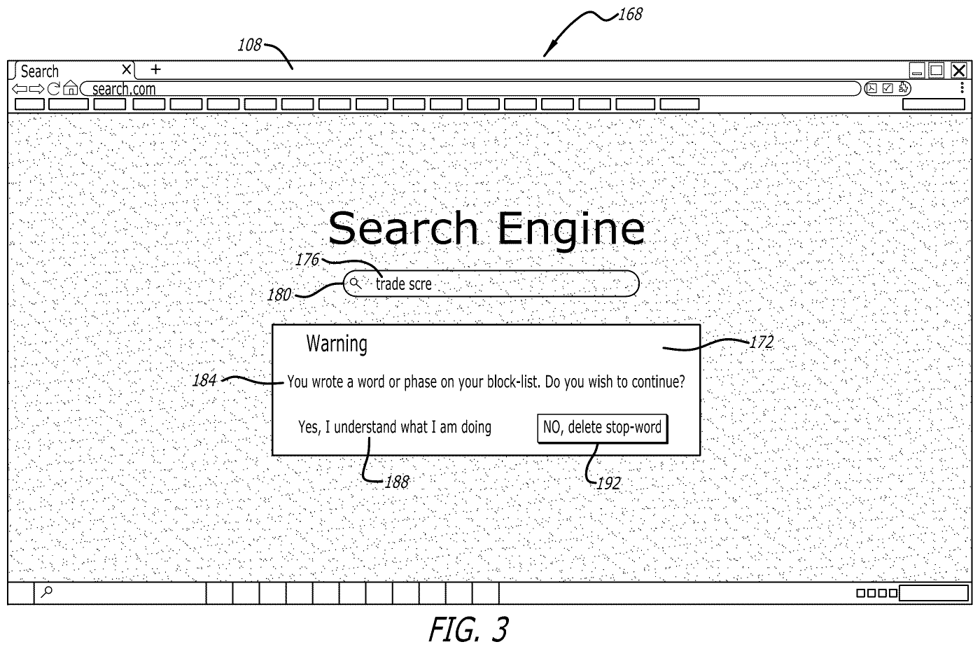

FIG. 3 illustrates a screenshot 168 of an exemplary embodiment of a Warning dialog box 172 displayed in a browser application 108. As mentioned hereinabove, when the browser extension recognition system determines that a word or phrase being typed matches a word or phrase in the Saved Words list 148, the browser extension recognition system prevents the word or phrase from being completely typed into the browser application 108. In the example illustrated in FIG. 3, blocked words 176 (e.g., a phrase) have been partially typed into a Search Engine box 180. Before the blocked words 176 could be completely typed, however, the browser extension recognition system locked the browser application 108 and displayed the Warning dialog box 172. As shown in FIG. 3, the Warning dialog box 172 includes a warning 184 indicating that the end-user typed a word or phrase included in the Saved Words list 148 and prompting the end-user to either continue typing the block words 176 or to stop typing the blocked words 176. To this end, the Warning dialog box 172 includes a Yes button 188 and a No button 192. Selecting the Yes button 188 enables the end-user to continue typing the blocked words 176 whereas selecting the No button 192 removes the block words 176 from the Search Engine box 180.

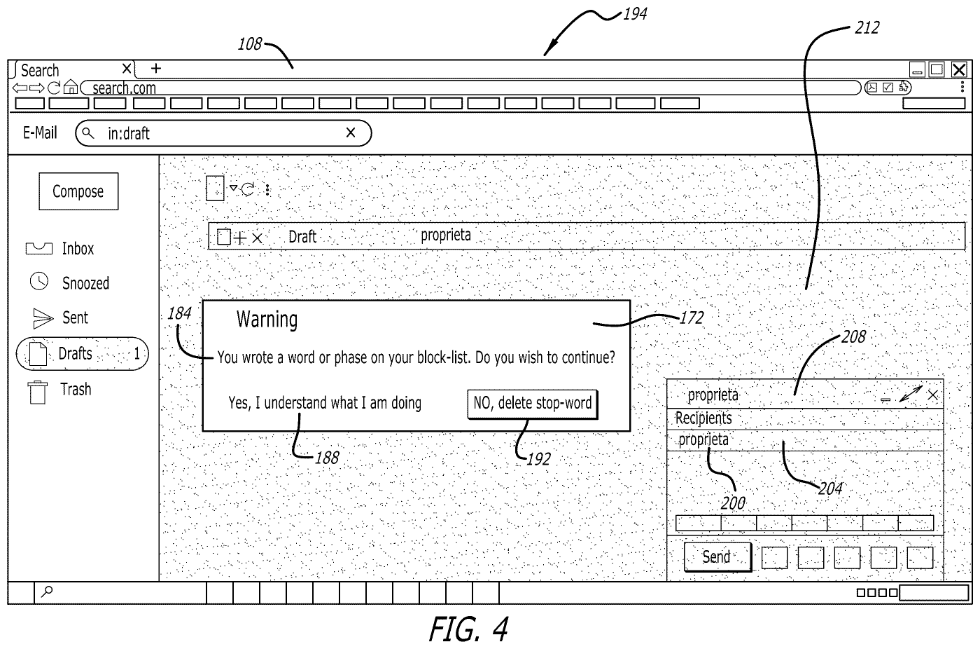

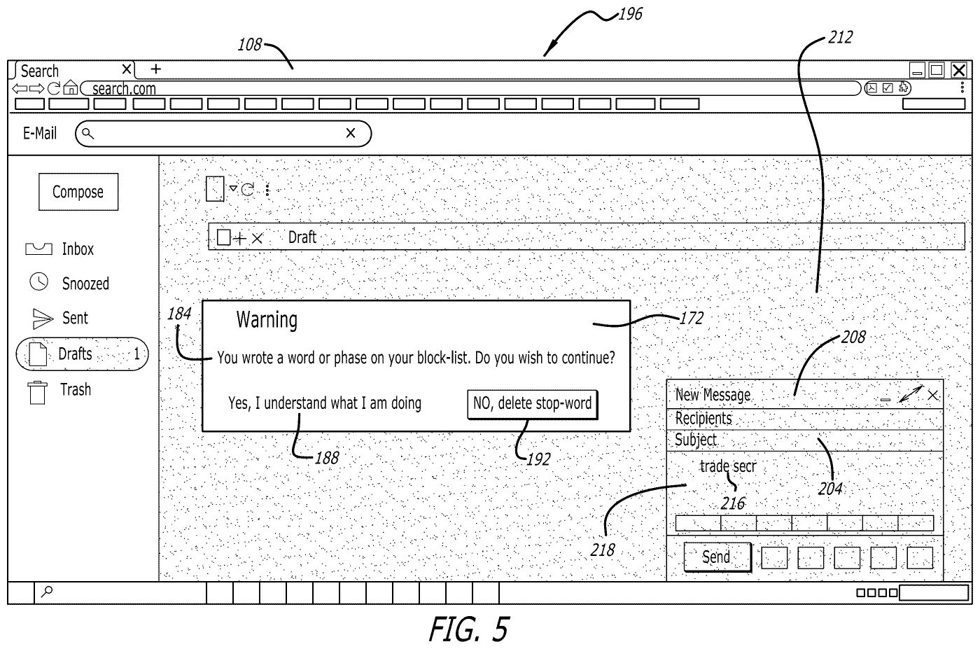

It should be understood the browser extension recognition system is not limited to blocking words typed into the Search Engine box 180, as shown in FIG. 3. Rather, the browser extension recognition system may be configured to block listed words and phrases from being typed in web-based applications that may be operated by way of the browser application 108. For example, FIG. 4 illustrates a screenshot 194 of an exemplary embodiment of a Warning dialog box 172 being displayed in response to blocked words 200 having been typed into a Subject box 204 of a New Message Window 208 in a web-based mail application 212 operating within the browser application 108. As discussed with respect to FIG. 3, the Warning dialog box 172 shown in FIG. 4 includes a warning 184 indicating that the end-user typed a word or phrase included in the Saved Words list 148 and prompts the end-user to either continue typing the block words 176 or to stop typing the blocked words 176. To this end, the Warning dialog box 172 includes a Yes button 188 and a No button 192. The end-user may select a Yes button 188 to continue typing the blocked words 200 or select a No button 192 to remove the block words 200 from the Subject box 204 of the New Message Window 208. In another example, FIG. 5 illustrates a screenshot 196 of the Warning dialog box 172 being displayed in response to a blocked phrase 216 having been typed into a Body field 218 of the New Message Window 208. As such, it should be understood that the browser extension recognition system blocks listed words and phrases typed anywhere within the browser application 108.

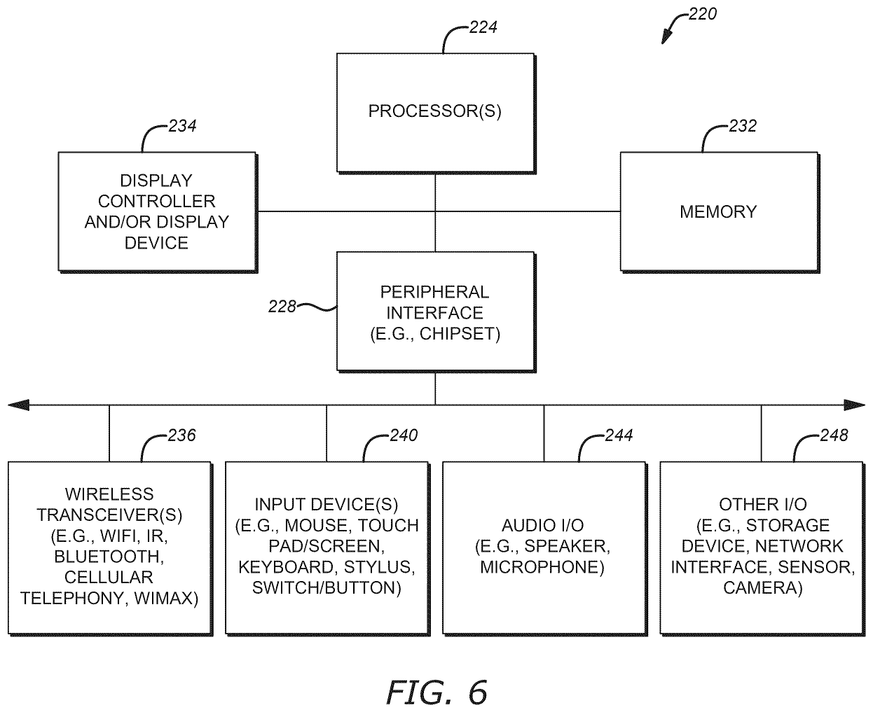

FIG. 6 is a block diagram illustrating an exemplary data processing system 220 that may be used in conjunction with the browser extension recognition system to perform any of the processes or methods described herein. System 220 may represent a desktop, a tablet, a server, a mobile phone, a personal digital assistant (PDA), a personal communicator, a network router or hub, a wireless access point (AP) or repeater, a set-top box, or a combination thereof.

In an embodiment, illustrated in FIG. 6, system 220 includes a processor 224 and a peripheral interface 228, also referred to herein as a chipset, to couple various components to the processor 224, including a memory 232 and devices 236-248 via a bus or an interconnect. Processor 224 may represent a single processor or multiple processors with a single processor core or multiple processor cores included therein. Processor 224 may represent one or more general-purpose processors such as a microprocessor, a central processing unit (CPU), or the like. More particularly, processor 224 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 224 may also be one or more special-purpose processors such as an application specific integrated circuit (ASIC), a field programmable gate array (FPGA), a digital signal processor (DSP), a network processor, a graphics processor, a network processor, a communications processor, a cryptographic processor, a co-processor, an embedded processor, or any other type of logic capable of processing instructions. Processor 224 is configured to execute instructions for performing the operations and steps discussed herein.

Peripheral interface 228 may include a memory control hub (MCH) and an input output control hub (ICH). Peripheral interface 228 may include a memory controller (not shown) that communicates with a memory 232. The peripheral interface 228 may also include a graphics interface that communicates with graphics subsystem 234, which may include a display controller and/or a display device. The peripheral interface 228 may communicate with the graphics device 234 by way of an accelerated graphics port (AGP), a peripheral component interconnect (PCI) express bus, or any other type of interconnects.

An MCH is sometimes referred to as a Northbridge, and an ICH is sometimes referred to as a Southbridge. As used herein, the terms MCH, ICH, Northbridge and Southbridge are intended to be interpreted broadly to cover various chips that perform functions including passing interrupt signals toward a processor. In some embodiments, the MCH may be integrated with the processor 224. In such a configuration, the peripheral interface 228 operates as an interface chip performing some functions of the MCH and ICH. Furthermore, a graphics accelerator may be integrated within the MCH or the processor 224.

Memory 232 may include one or more volatile storage (or memory) devices, such as random access memory (RAM), dynamic RAM (DRAM), synchronous DRAM (SDRAM), static RAM (SRAM), or other types of storage devices. Memory 232 may store information including sequences of instructions that are executed by the processor 224, or any other device. For example, executable code and/or data of a variety of operating systems, device drivers, firmware (e.g., input output basic system or BIOS), and/or applications can be loaded in memory 232 and executed by the processor 224. An operating system can be any kind of operating systems, such as, for example, Windows® operating system from Microsoft®, Mac OS®/iOS® from Apple, Android® from Google®, Linux®, Unix®, or other real-time or embedded operating systems such as Vx Works.

Peripheral interface 228 may provide an interface to IO devices, such as the devices 236-248, including wireless transceiver(s) 236, input device(s) 240, audio IO device(s) 244, and other IO devices 248. Wireless transceiver 236 may be a WiFi transceiver, an infrared transceiver, a Bluetooth transceiver, a WiMax transceiver, a wireless cellular telephony transceiver, a satellite transceiver (e.g., a global positioning system (GPS) transceiver) or a combination thereof. Input device(s) 240 may include a mouse, a touch pad, a touch sensitive screen (which may be integrated with display device 234), a pointer device such as a stylus, and/or a keyboard (e.g., physical keyboard or a virtual keyboard displayed as part of a touch sensitive screen). For example, the input device 240 may include a touch screen controller coupled with a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

Audio IO 244 may include a speaker and/or a microphone to facilitate voice-enabled functions, such as voice recognition, voice replication, digital recording, and/or telephony functions. Other optional devices 248 may include a storage device (e.g., a hard drive, a flash memory device), universal serial bus (USB) port(s), parallel port(s), serial port(s), a printer, a network interface, a bus bridge (e.g., a PCI-PCI bridge), sensor(s) (e.g., a motion sensor, a light sensor, a proximity sensor, etc.), or a combination thereof. Optional devices 248 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips.

Note that while FIG. 6 illustrates various components of a data processing system, it is not intended to represent any particular architecture or manner of interconnecting the components; as such details are not germane to embodiments of the present disclosure. It should also be appreciated that network computers, handheld computers, mobile phones, and other data processing systems, which have fewer components or perhaps more components, may also be used with embodiments of the invention disclosed hereinabove.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it should be appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The techniques shown in the figures can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals-such as carrier waves, infrared signals, digital signals).

The processes or methods depicted in the preceding figures may be performed by processing logic that comprises hardware (e.g., circuitry, dedicated logic, etc.), firmware, software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

While the browser extension recognition system and methods have been described in terms of particular variations and illustrative figures, those of ordinary skill in the art will recognize that the browser extension recognition system is not limited to the variations or figures described. In addition, where methods and steps described above indicate certain events occurring in certain order, those of ordinary skill in the art will recognize that the ordering of certain steps may be modified and that such modifications are in accordance with the variations of the browser extension recognition system. Additionally, certain of the steps may be performed concurrently in a parallel process when possible, as well as performed sequentially as described above. To the extent there are variations of the browser extension recognition system, which are within the spirit of the disclosure or equivalent to the browser extension recognition system found in the claims, it is the intent that this patent will cover those variations as well. Therefore, the present disclosure is to be understood as not limited by the specific embodiments described herein, but only by scope of the appended claims.

What is claimed is:

1. A browser extension recognition system for blocking words from being typed in a browser application, the system comprising:
a browser action for installation as a part of the browser application; and
a list of words for being blocked in the browser application.

2. The system of claim 1, wherein a browser action icon is associated with the browser action and displayed in the browser application.

3. The system of claim 2, wherein a recognition system dialog box is configured to be displayed when the browser action icon is selected.

4. The system of claim 3, wherein the recognition system dialog box includes content specified by the browser extension recognition system and instructions contained in one or more background elements that provide functionality for operation of the browser extension recognition system.

5. The system of claim 3, wherein the recognition system dialog box includes controls configured to enable the end-users to manage the list of words.

6. The system of claim 5, wherein the controls facilitate adding new words and phrases to the list of words and removing existing words and phrases from the list of words.

7. The system of claim 5, wherein the controls include a protection switch configured to switch the browser extension recognition system between an Off state and an On state.

8. The system of claim 5, wherein the controls include a Settings button that is configured to be selected so as to display a settings dialog box.

9. The system of claim 8, wherein the settings dialog box includes controls configured to enable the end-users to control the operation of the browser extension recognition system.

10. The system of claim 9, wherein the settings dialog box includes a list of all words and phrases to be blocked in the browser application.

11. The system of claim 10, wherein the settings dialog box facilitates adding new words and phrases to the list of words and removing existing words and phrases from the list of words.

12. The system of claim 10, wherein the settings dialog box is configured to enable the end-user to import an external file that contains a desired group of words and/or phrases to be blocked in the browser application.

13. The system of claim 10, wherein the settings dialog box is configured to enable the end-user to create an external file that contains a listing of all the words and phrases comprising the list of words.

14. The system of claim 1, wherein a warning dialog box is displayed when a word or phrase being typed is determined to match a word or phrase in the list of words.

15. The system of claim 14, wherein the display of the warning dialog box prevents the word or phrase from being completely typed into the browser application.

16. The system of claim 14, wherein the warning dialog box includes a warning indicating that the typed word or phrase matches a blocked word or phrase and prompts the end-user to either continue or stop typing the block word or phrase.

17. A method for blocking words from being typed in a browser application, comprising:
installing a browser action as a part of the browser application;
selecting a browser action icon to display a recognition system dialog box;
managing a list of blocked words and phrases; and
responding to a warning dialog box when the blocked words and phrases are detected.

18. The method of claim 17, wherein managing includes adding new words and phrases to the list of blocked words and phrases and removing existing words and phrases from the list of blocked words and phrases.

19. The method of claim 17, wherein managing includes importing an external file that contains the list of blocked words and phrases to be blocked in the browser application.

20. The method of claim 17, wherein managing includes creating an external file that contains a listing of all the words and phrases comprising the list of blocked words and phrases.
